(19) United States
(12) Patent Application Publication
(10) Pub. No.: US 2012/0091679 A1
(43) Pub. Date: Apr. 19, 2012

(54) Active Chassis Stabilization System

(75) Inventors: Keiwan Kashi, Dusseldorf (DE); Stephan Walentowski, Dusseldorf (DE); Dirk Nissing, Alpen (DE)

(73) Assignee: TRW AUTOMOTIVE GMBH, Alfdorf (DE)

(21) Appl. No.: 13/322,168

(22) PCT Filed: May 26, 2010
(86) PCT No.: PCT/EP10/03191

§ 371 Date: Dec. 13, 2011

(30) Foreign Application Priority Data
May 27, 2009 (DE) 102009022763.6

(51) Int. Cl. B60P 1/16

(52) U.S. Cl. 280/124.112

(57) ABSTRACT

The invention relates to an active chassis stabilization system including a hydraulic actuator, a pump for acting upon the actuator with a hydraulic pressure, a reservoir for receiving hydraulic fluid, and a return line for a fluid flow from the actuator to the reservoir. Provided in the return line is a check valve which blocks the fluid flow from the reservoir to the actuator and allows the fluid flow from the actuator to the reservoir as of a predeterminable return pressure.

### CROSS-REFERENCE TO RELATED APPLICATIONS

This application is a national stage of International Application No. PCT/EP2010/003191 filed May 26, 2010, the disclosures of which are incorporated herein by reference in entirety, and which claimed priority to German Patent Application No. 10 2009 022 763.6 filed May 27, 2009, the disclosures of which are incorporated herein by reference in entirety.

### BACKGROUND OF THE INVENTION

The invention relates to an active chassis stabilization system including at least one hydraulic actuator, a pump for acting upon the actuator with a hydraulic pressure, a reservoir for receiving hydraulic fluid, and a return line for a fluid flow from the actuator to the reservoir, a check valve being provided in the return line.

Active chassis stabilization systems for roll stabilization of motor vehicles are generally known. They are more particularly able to counter rolling motions of the vehicle body, that is, rotational motions about the longitudinal axis of the vehicle, in order to generate a desired vehicle handling. A desired roll moment may be realized by means of a rotational actuator, for example, which is integrated in a torsion rod of a stabilizer bar, or by means of a linear actuator which is arranged between a stabilizer bar arm and a wheel suspension.

In the event of an external excitation of the vehicle wheels, for example as caused by road damage, the stabilizer bars of conventional passive chassis stabilization systems are deformed and generate a possibly undesirable stabilizer bar moment on the vehicle body. In active chassis stabilization systems, the actuator is deflected/moved passively (i.e. without a pressure build-up) in the case of external, forced wheel motions and thus allows a compensation of the wheel deflection without exerting a stabilizer bar moment upon the vehicle body.

This passive actuator deflection causes a pressure chamber of the actuator to become smaller, which means that hydraulic fluid flows out of the pressure chamber, whereas a different pressure chamber of the actuator increases in size, which means that an inflow of hydraulic fluid is necessary. Preferably, within the scope of the usual system function, one pressure chamber is always connected with the pump line and the other pressure chamber with the reservoir line.

In the event that the pressure chamber associated with the reservoir line becomes larger, a pressure drop below atmospheric pressure is possible since the actuator is required to pull hydraulic fluid from the reservoir through the respective lines and, if required, an electrohydraulic control unit. In particular in the case of rapid actuator movements there is a high probability of a heavy pressure drop. The necessary fluid flow to the actuator is determined here by the pressure gradient between the reservoir and the expanding pressure chamber of the actuator. Since the reservoir is usually a tank under atmospheric pressure, that is, under a pressure of about 1 bar, the pressure in the expanding pressure chamber may drop sharply especially in the case of a rapid actuator movement forced from outside. If the pressure of the hydraulic fluid in the pressure chamber drops below a predetermined value (for example 0.7 bar, depending on the boundary conditions), this results in cavitation phenomena, that is, in a temporary formation of small gas bubbles in the pressure chamber of the actuator which implode again after a short time. This phenomenon of cavitation leads to an undesirable noise nuisance and may also cause damage to the material in the longer run.

To reduce the risk of cavitation, the generic document WO 2007/020052 proposes a chassis stabilization system in which the fluid return flow, at least in sections, also has a minimum pressure, that is, a pressure that is above the reservoir pressure. The minimum pressure is adjusted here by means of a throttle valve connected into the return line.

When the delivery rate of the pump is substantially constant, a largely constant minimum pressure develops upstream of the throttle valve, depending on the opening cross-section of the throttle valve. However, it has meanwhile been found that considerable savings on energy can be realized if the pump operates with a variable delivery rate that is adapted to the demand. But this leads to the undesirable effect that the minimum pressure in the return flow is dependent on the delivery rate of the pump.

### BRIEF SUMMARY OF THE INVENTION

It is therefore a feature of the invention to provide an active chassis stabilization system which provides a largely constant return flow pressure for the prevention of cavitation even in the case of a variable hydraulic fluid flow rate.

This feature is achieved by an active chassis stabilization system of the type mentioned at the outset, in which the check valve in the return line blocks the fluid flow from the reservoir to the actuator and allows the fluid flow from the actuator to the reservoir as of a predeterminable return pressure. This passive check valve is a low-cost and reliable component for controlling the fluid flow; it can, in a simple manner, replace the throttle valve provided in the prior art and can therefore keep the return pressure substantially constant even with a variable delivery rate of the pump.

The check valve preferably includes a spring member which urges the check valve into its blocking position. The predeterminable return pressure can thus be set at a desired value in a simple manner by means of a spring stiffness of the spring member.

In a particularly preferred embodiment, an anti-cavitation valve that is connected in parallel with the check valve is provided in the return line, the anti-cavitation valve blocking the fluid flow from the actuator to the reservoir and allowing the fluid flow from the reservoir to the actuator below a predeterminable anti-cavitation pressure. Should the return pressure drop below the reservoir pressure, for example as a result of a forced external movement of a vehicle wheel, this anti-cavitation valve ensures the possibility of pulling hydraulic fluid from the reservoir into the expanding pressure chamber of the actuator.

In an advantageous further development of the invention, the chassis stabilization system comprises a plurality of actuators which can be acted upon with a hydraulic pressure by the pump.

Provision may be made here for one single hydraulic channel, so that exactly one degree of freedom results therefrom for the hydraulic pressure for acting upon the actuators. Alternatively or additionally, a plurality of hydraulic channels may be provided in communication with a plurality of actuators, so that the number of resultant degrees of freedom for the hydraulic pressure corresponds to the number of hydraulic channels.

Further advantageous and expedient configurations of the inventive concept will be apparent from the dependent claims.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a schematic basic diagram of an active chassis stabilization system according to the invention;

FIG. 2 shows an exemplary, schematic hydraulic circuit diagram of the active chassis stabilization system according to the invention;

FIG. 3 shows a part of a schematic hydraulic circuit diagram of a further embodiment of the chassis stabilization system according to the invention; and

FIG. 4 shows a part of a schematic hydraulic circuit diagram of a further embodiment of the chassis stabilization system according to the invention.

### DETAILED DESCRIPTION OF THE INVENTION

FIG. 1 shows an active chassis stabilization system 10 for a vehicle. In the present case, a rear axle of the vehicle is illustrated by way of example, the idea of the invention being, of course, not restricted to vehicle rear axles.

As shown in FIG. 1, the rear axle comprises a wheel suspension 12 as is known from the prior art, having a right-hand semi-trailing arm 14, a left-hand semi-trailing arm 16, and a stabilizer bar 18 having one end that engages the left-hand semi-trailing arm 16 and having another end that is connected to the right-hand semi-trailing arm 14 by means of an actuator 20.

The actuator 20 is in the form of a cylinder/piston unit 22, a cylinder 24 being connected with the stabilizer bar 18, and a piston 26 that is accommodated for longitudinal displacement in the cylinder 24 being connected with the right-hand semi-trailing arm 14.

In an alternative embodiment, the actuator 20 may be in the form of a rotational actuator rather than in the form of a linear actuator and may be integrated in the stabilizer bar 18.

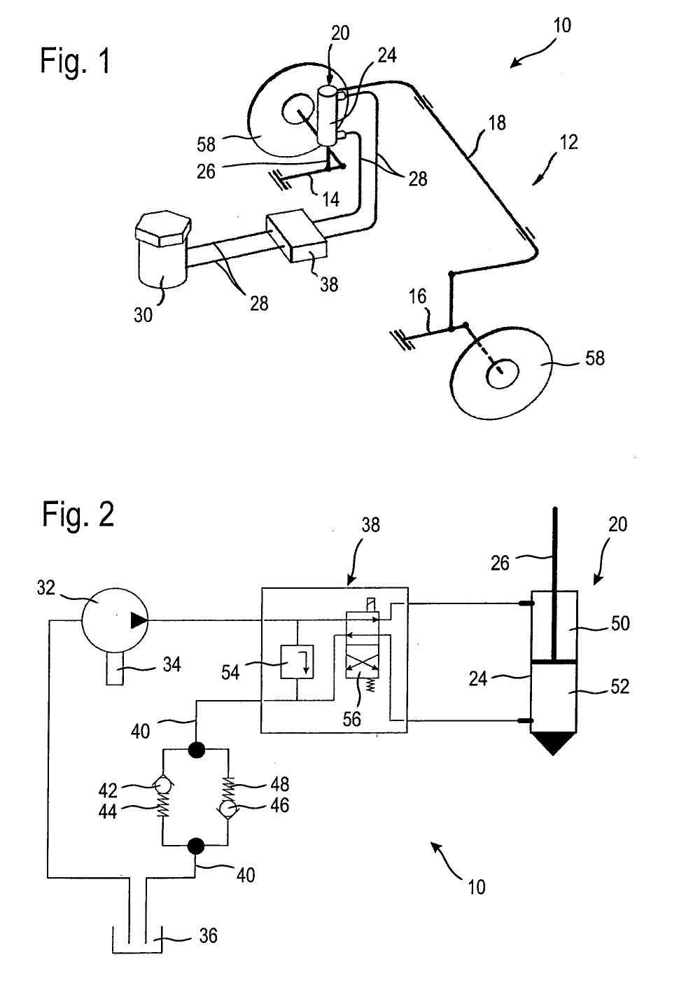

The actuator 20 is connected with a motor pump unit 30 via hydraulic lines 28, the motor pump unit 30 preferably including a pump 32, a motor 34 for operating the pump 32, a reservoir 36 (cf. also FIG. 2) and, optionally, an electronic control unit (not shown). The individual components of the motor pump unit 30 need, of course, not be combined to form a structural unit, but may also be provided separately from each other as individual components (FIG. 2).

As an alternative, the actuator 20 may also be connected to a flow controlled pump which exerts a hydraulic pressure on the actuator 20. Such a flow controlled pump may be driven by means of the internal combustion engine, with other types of drive also being possible.

Connected between the motor pump unit 30 and the actuator 20 in FIG. 1 is an electrohydraulic control unit 38 which comprises at least one valve and means for driving the at least one valve.

FIG. 2 shows the active chassis stabilization system 10, more precisely the schematic hydraulic circuit diagram of the active chassis stabilization system 10, including, by way of example, a hydraulic actuator 20, the pump 32 for acting upon the actuator 20 with a hydraulic pressure, the reservoir 36 for receiving hydraulic fluid, and a return line 40 for a fluid flow from the actuator 20 to the reservoir 36, a check valve 42 being provided in the return line 40. The check valve 42 is built into the return line 40 in such a way that it blocks the fluid flow from the reservoir 36 to the actuator 20 and allows the fluid flow from the actuator 20 to the reservoir 36 as of a predeterminable return pressure. To define the predeterminable return pressure, the check valve 42 includes a spring member 44 which urges the check valve 42 into its blocking position. Using the spring stiffness of the spring member 44, the return pressure upstream of the check valve 42 can be set with little effort. This return pressure is more particularly independent of a delivery rate of the pump 32. Accordingly, energy-saving pumps 32 having an adjustable, variable pump flow rate can be made use of without difficulty and without any undesirably large fluctuations in the return pressure occurring. The delivery rate of the pump 32 is preferably adapted to the demand in the active chassis stabilization system 10 by means of an electronic control system.

As shown in FIG. 2, an anti-cavitation valve 46 that is connected in parallel with the check valve 42 is provided in the return line 40, the anti-cavitation valve 46 blocking the fluid flow from the actuator 20 to the reservoir 36 and allowing the fluid flow from the reservoir 36 to the actuator 20 below a predeterminable anti-cavitation pressure. Analogously with the check valve 42, the anti-cavitation valve 46, which is configured as a check valve, also includes a spring member 48 which urges the anti-cavitation valve 46 into its blocking position to define the predeterminable anti-cavitation pressure. The spring member 48 preferably has an extremely low spring stiffness, so that a pulling of hydraulic fluid from the reservoir 36 into a pressure chamber 50 or a pressure chamber 52 of the actuator 20 by means of the anti-cavitation valve 46 is already allowed when the hydraulic pressure in one of the pressure chambers 50, 52 drops only slightly below a hydraulic pressure in the reservoir 36. In particular, the spring member 48 of the anti-cavitation valve 46 has a lower spring stiffness than the spring member 44 of the check valve 42.

As shown in FIG. 2, the pump 32, the reservoir 36, and the actuator 20 are connected to the electrohydraulic control unit 38, the return line 40 connecting the electrohydraulic control unit 38 and the reservoir 36. As indicated in FIG. 1, a section of the return line 40 together with the check valve 42 and the anti-cavitation valve 46 may be integrated in the electrohydraulic control unit 38. In addition, the electrohydraulic control unit 38 includes at least one valve for driving the actuator 20 as well as means for actuating the at least one valve. Merely for the purpose of illustrating a possible actuator control system, the electrohydraulic control unit 38 according to FIG. 2 includes, by way of example, a pressure control valve 54 and a 4/2-way valve 56.

In the valve position illustrated, the pressure chamber 50 of the actuator 20 is connected with the pump 32 and the pressure chamber 52 of the actuator 20 is connected with the reservoir 36. When a displacement of the piston 26 toward the pressure chamber 52 (downward in FIG. 2) is produced by the excitation of a vehicle wheel 58 (cf. FIG. 1), the risk of cavitation is low since the pump 32 is able to quickly deliver hydraulic fluid into the pressure chamber 50.

When the piston 26 is displaced toward the pressure chamber 50 (upward in FIG. 2) as a result of an external excitation, the return pressure prevailing between the actuator 20 and the check valve 42 provides for a fluid flow toward the pressure chamber 52. Since the piston movement causes hydraulic fluid to flow out of the pressure chamber 50 via the pressure control valve 54 to the section of the return line 40 which is under the predeterminable return pressure, the return pressure decreases only slowly. The hydraulic fluid is directed from the pressure chamber 50 via the pressure control valve 54 directly to the pressure chamber 52. It is not until the return pressure, that is, the hydraulic pressure in the pressure chamber 52, falls below the hydraulic pressure in the reservoir 36, that is, as a rule, atmospheric pressure, that the anti-cavitation valve 46 will open and allow hydraulic fluid to be pulled from the reservoir 36.

When the return pressure is suitably selected, it is almost excluded that the hydraulic pressure in the pressure chamber 52 decreases to a cavitation-critical range. It is of particular advantage here that this desired return pressure is kept largely constant by the check valve 42 even in the case of a variable delivery rate of the pump 32.

When the actuator 20 is moved due to an external excitation while the 4/2-way valve 56 connects the pressure chamber 50 with the reservoir 36 and the pressure chamber 52 with the pump 32, the above explanations are applicable analogously, but for opposite piston movements.

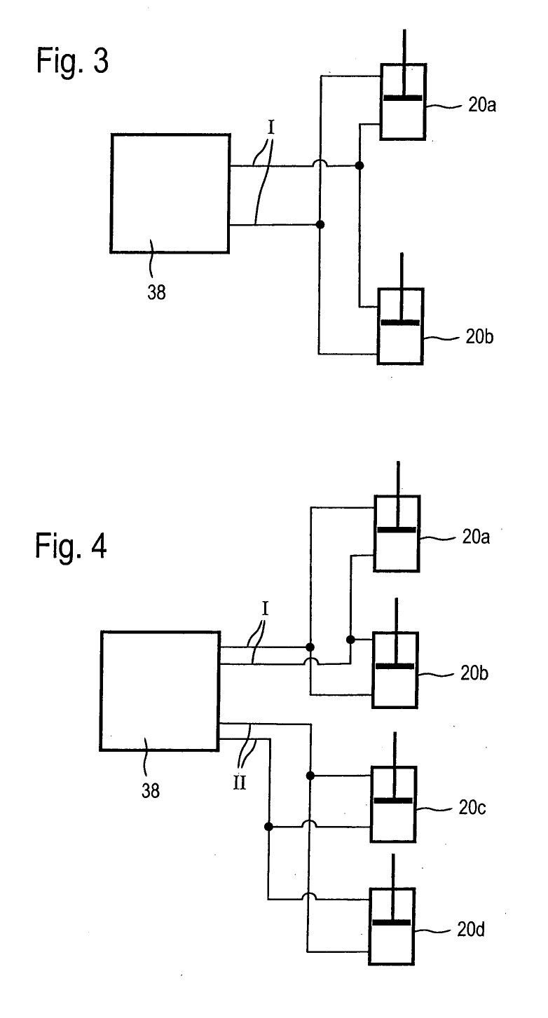

In the embodiment according to FIG. 2, one actuator 20 is connected to the control unit 38. FIG. 3, in contrast, shows a part of a hydraulic circuit diagram according to a further embodiment of the chassis stabilization system 10 in which two actuators 20a, 20b are connected to the control unit 38 via a hydraulic channel I. Exactly one hydraulic pressure or degree of freedom can be set in the channel I.

FIG. 4 shows a further embodiment of the chassis stabilization system 10 in which a plurality of actuators 20a, 20b, 20c, 20d are connected to the control unit 38 via a plurality of hydraulic channels I, II. Two actuators 20a, 20b are connected to the control unit 38 via a first hydraulic channel I, and two further actuators 20c, 20d are connected to the control unit 38 via a second hydraulic channel II. A pressure can be set in the two hydraulic channels I, II, each independently of each other, so that the hydraulic channels I, II are independent of each other and two degrees of freedom exist for the hydraulic pressure.

The embodiments according to FIGS. 3 and 4 differ from the embodiment according to FIG. 2 essentially only by the number of actuators connected to the control unit 38. The remaining system structure and the mode of operation correspond to that of the embodiment according to FIG. 2, for which reason reference is made thereto in order to avoid repetitions.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An active chassis stabilization system comprising
at least one hydraulic actuator,
a pump for acting upon the at least one actuator with a hydraulic pressure,
a reservoir for receiving hydraulic fluid, and
a return line for a fluid flow from the at least one hydraulic actuator to the reservoir, a check valve being provided in a return line,
wherein the check valve blocks the fluid flow from the reservoir to the at least one hydraulic actuator and allows the fluid flow from the actuator to the reservoir as of a predeterminable return pressure.

2. The chassis stabilization system according to claim 1, wherein the check valve includes a spring member which urges the check valve into a blocking position and defines the predeterminable return pressure.

3. The chassis stabilization system according to claim 1 wherein an anti-cavitation valve that is connected in parallel with the check valve is provided in the return line, the anti-cavitation valve blocking the fluid flow from the at least one hydraulic actuator to the reservoir and allowing the fluid flow from the reservoir to the actuator below a predeterminable anti-cavitation pressure.

4. The chassis stabilization system according to claim 3, wherein the anti-cavitation valve includes a spring member which urges the anti-cavitation valve into its blocking position and defines the predeterminable anti-cavitation pressure.

5. The chassis stabilization system according to claim 1, wherein the pump, the reservoir, and the at least one hydraulic actuator are connected to an electrohydraulic control unit, the return line connecting the electrohydraulic control unit and the reservoir.

6. The chassis stabilization system according to claim 5, wherein at least one of (a) a section of the return line, (b) together with the check valve, and/or (c) the anti-cavitation valve is integrated in the electrohydraulic control unit.

7. The chassis stabilization system according to claim 1, wherein the pump has an adjustable, variable pump flow rate.

8. The chassis stabilization system according to claim 1, wherein a stabilizer bar is provided that is coupled to the at least one hydraulic actuator.

9. The chassis stabilization system according to claim 1, wherein the actuator (20) is a cylinder/piston unit (22).

10. The chassis stabilization system according to claim 1, wherein a plurality of actuators is provided.

11. The chassis stabilization system according to claim 10, wherein a total of one hydraulic channel is provided which has the plurality of actuators connected thereto.

12. The chassis stabilization system according to claim 10, wherein a plurality of hydraulic channels is provided in communication with the plurality of actuators.
